(19) United States
(12) Patent Application Publication
(10) Pub. No.: US 2008/0034717 A1
(43) Pub. Date: Feb. 14, 2008

(54) COMPRESSED AIR CLEANER UTILIZING A CENTRIFUGAL IMPELLER AND SPIRAL GROOVES

(76) Inventor: Jang-Shik Yun, Daejeon (KR)

Correspondence Address: BROOKS KUSHMAN P.C., 1000 TOWN CENTER, TWENTY-SECOND FLOOR, SOUTHFIELD, MI, 48075, US

(21) Appl. No.: 11/576,741

(22) PCT Filed: Sep. 15, 2005
(86) PCT No.: PCT/KR05/03061

§ 371 Date: Apr. 5, 2007

(30) Foreign Application Priority Data
Oct. 6, 2004 (KR) 10-2004-0079691

(51) Int. Cl. B01D 45/00

(52) U.S. Cl. 55/437

(57) ABSTRACT

This invention relates to a compressed gas cleaner utilizing a centrifugal impeller and spiral grooves by spinning a centrifugal impeller automatically with the dynamic power of compressed gas from a compressor, thus the separation of liquid, water, oil sludge and particular pollution dust can be completely cleaned with the spiral grooves instead of solid filters on the basis of specific difference, 1 to 1000, between gas and liquid. A compressed gas cleaner utilizing a centrifugal impeller and spiral grooves comprising: the spiral grooves for generating centrifugal gas stream without loss of pressure and the path of a liquid flow without sludge plugging on the basis of the labyrinth principle. Thus it is upgraded for a higher gas cleaning efficiency, 99.9% without any kind of solid filtering elements, drying chemicals and dehumidifying refrigerators on the basis of simple parts and structure for horizontal piping, low manufacturing fee, easy assembly and free maintenance for many years.

### TECHNICAL FIELD

This invention relates to a compressed air cleaner utilizing a centrifugal impeller and spiral grooves, thus the separation of dirty liquid including water, oil and particular pollution dust can be carried out with the centrifugal power efficiently from compressed air.

Compressed air generation uses an expensive cost of input energy, however compressed air includes lot of water, coolant oil, carbonated material and rusted pollution contaminants. Thus compressed air typically must be dry and purify for the usual applications. Besides the need for clean ambient air, it should be stressed that the quality of compressed air is important.

The need for high standards of compressed air purity for many uses is obvious, particularly for electronic industry, automobile industry, food processing, pharmaceutical manufacturing, hospital tools and other highly precession controlled operations.

In numerous situations, a continuous liquid or gas phase is subject to the accumulation of contaminants in the form of solid particles, liquids and/or gases, which must be subjected to filtration and separation as attempted by numerous techniques of the prior art. The contaminating material may, for example, be present as a solid, liquid, or gas within a gas media, or dispersed as a solid, liquid or gas within a liquid. Foreign matter is prevalent, for example, in pneumatic lines used in conjunction with air brakes for trucks, buses and heavy equipment, as well as for protecting other pneumatically operated devices such as doors, cylinders, etc.

Many devices in the prior art have relied upon the phenomenon of coalescing dispersed liquid from a fluid as a means to overcome the problems inherent in the accumulation of liquid in a fuel line. Such coalescing devices rely on a coalescing material to coalesce the liquids into droplets that are more readily separated from the fuel than in the dispersed state.

Some of the prior art devices may operate satisfactorily at low flow rates through the separator, but as the compressor output increases, the flow rate becomes greater and efficiency of coalescing and separation then suffers in such devices resulting in water particles, and the like, being delivered to the air compressor. The overall deficiency of such coalescing systems has resulted, in part, from the ineffective cooperation between the incoming flow and the coalescing stage. Moreover, well known coalescing-type apparatus have failed to provide or have not provided sufficient filtration of solids prior to entry to the coalescing stage, because of which the coalescing operation becomes less efficient due to the interfering presence of solids. The prior art coalescing devices have not further provided effective filtration and separation at all flow rates through the separator, with a resulting decrease of efficiency.

Accordingly, the known techniques of filtering and separating contaminants from high-pressure gas stream have not attained the optimum level of efficiency to accomplish removal of solids, dispersed liquids from gas stream at all demand levels of the pneumatic tools especially for semiconductor manufacturing industry, for medical and hospital tools and equipment and for various precisely electronic controlled pneumatic tools.

### BACKGROUND ART

The present invention has been improved from PCT International Publication Number WO 2004/053305: “AIR PURIFICATION APPARATUS UTILIZING A CENTRIFUGAL IMPELLER” assigned with same applicant and inventor, YUN, Jangshik, and It is cited with reference parts and numbering based on 20-0328651: the ROK registration No. of utility model, “centrifugal type of air cleaner”, application laid-open No. 10-2004-0043138: “air cleaner utilizing a centrifugal impeller”, and application laid-open No. 10-2004-0043138: “air cleaner utilizing a centrifugal impeller” assigned with same applicant and inventor, YUN, Jangshik.

There are the problems described with the followings according to PCT International Publication Number WO 2004/053305: “AIR PURIFICATION APPARATUS UTILIZING A CENTRIFUGAL IMPELLER” assigned with same applicant and inventor, YUN, Jangshik;

1. Low compressed air purification efficiency with a carryover liquid mixed in discharging compressed air through outlet: since the turbulent flow of compressed air was generated on a porous filter, Thus it is improved for a liquid drain gap formed between the circumferential side of spiral grooves and the inner wall of housing on the basis of Labyrinth principle: therefore it is generated efficiently for the vortex flow of compressed air, thus liquid is better separated with a centrifugal force from the vortex flow of compressed air and passed downwardly with a gravitational force to the liquid drain holes through a liquid drain gap between the circumferential side of spiral grooves and the inner wall of housing. Meanwhile the vortex flow of compressed air may be not passed through a liquid drain gap between the circumferential side of spiral grooves and the inner wall of housing on the basis of Labyrinth principle. Therefore it is prepared for a liquid drain gap formed between the circumferential side of spiral grooves 216 and inner wall of a housing 209, and a spiral air passage formed between the circumferential side of spiral grooves 216 and inner wall of a housing 209 on the basis of labyrinth principle.

2. Vertical piping, it is inconvenient for installing a compressed air cleaner on a pipe in industry, since a compressed air cleaner may be usually installed with a horizontal pipe in industrial facility Thus it is improved for arranging an inlet nipple and an outlet nipple horizontally on the structure of a housing. Thus an inlet air passage 231 and an inlet air passage 232 are formed horizontally with same level on the circumferential surface of a housing 209.

3. A shaft fixed with both ends: a one arm shaft fixed with one end may be lack of the durability on its structure, Thus it is improved for a mechanical life with a shaft fixed with both ends.

4. Expensive manufacturing cost, lot of complex parts make an expensive manufacturing cost for a product: Thus it may be improved for low manufacturing cost and easy maintenances with three major parts.

5. Complex maintenance with lot of parts: it may be improved for a mass cast producing, maintenance, assembling and disassembling with three major parts or a small number of parts on its structure.

### DISCLOSURE OF INVENTION

### Technical Problem

There are the improvements described with the followings, a compressed air cleaner utilizing a centrifugal impeller and spiral grooves according to the present invention;

1. Upgrading purification efficiency: it may be improved for compressed air purification efficiency without pressure loss and sludge clogging. Thus it may be prepared a liquid drain gap between the circumferential side of spiral grooves and the inner wall of housing on the basis of Labyrinth principle, since it is generated efficiently for the vortex flow of compressed air, further liquid is better separated with a centrifugal force from the vortex flow of compressed air and passed downwardly with a gravitational force to the liquid drain holes through a liquid drain gap between the circumferential side of spiral grooves and the inner wall of housing. Furthermore the vortex flow of compressed air may be not passed through a liquid drain gap between the circumferential side of spiral grooves and the inner wall of housing on the basis of Labyrinth principle. Therefore a liquid drain gap is formed for separating liquid from compressed air between the circumferential side of spiral grooves 216 and inner wall of a housing 209, a spiral air passage is formed annually for passing the vortex flow of compressed air between the circumferential side of spiral grooves 216 and inner wall of a housing 209 on the basis of labyrinth principle.

2. Horizontal piping: It may be usually installed for a compressed air cleaner on a horizontal pipe in industrial facility. Thus it is improved for arranging an inlet nipple and an outlet nipple horizontally on the structure of a housing. Therefore an inlet air passage 231 and an outlet air passage 232 are formed horizontally with same level on the circumferential surface of a housing 209.

3. A shaft fixed with both ends: It may be lack of the durability on the structure of a one arm shaft fixed with one end. Therefore it may be improved for a mechanical life with a shaft fixed with both ends.

4. Low mass cast-manufacturing cost: It may be improved for simplifying with low mass cast-manufacturing cost and easy maintenances.

5. Simple structure with a small number of parts: Lot of complex parts including a filter, a porous separation cylinder are eliminated on its structure of a compressed air cleaner. Thus it is improved for a mass cast producing on the basis of three major parts.

6. Easy maintenance: It is improved for assembling and disassembling on the basis of three major parts.

### Technical Solution

The present invention has been developed to overcome the above-mentioned problems of the prior art, and accordingly it is an object of the present invention to provide a compressed air cleaner utilizing a centrifugal impeller and spiral grooves by operating with the jet power of compressed air for removing centrifugally liquid and particulate matter from a gas stream on the pneumatic line, comprising; a vortex cylinder 213 located inside of a housing 209, a separating plate 260 located on the upper side of a vortex cylinder 213, spiral grooves 216 formed on the circumferential surface of a vortex cylinder 213 for separating liquid from compressed air with centrifugal force after forming vortex flow and draining liquid in keeping with the vortex flow of compressed air on the basis of labyrinth principle, and a hallow shaft 235 fixed on its both ends between a housing 209 and a vortex cylinder 213, a centrifugal impeller 208 and a bearing 234 installed on a hollow shaft 235, and multiple air passages 250 formed on the circumferential surface of a vortex cylinder 213 at the lower side of spiral grooves 216, a center drain hole 223 formed at the bottom side of a vortex cylinder 213, a drain plate 224 located on the bottom side of spiral grooves 216, multiple drain holes 222 formed on a drain plate 224, a drain bowl 219 located on the bottom side of a drain plate 224, a drain outlet 211 installed for connecting a liquid trap 241 on the bottom side of a drain bowl 219;

Also, it is an object of the present invention to provide a compressed air cleaner utilizing a centrifugal impeller and spiral grooves by operating with the rotation power of an electric motor for removing centrifugally liquid and particulate matter from a gas stream on the pneumatic line, comprising; a vortex cylinder 413 located inside of a housing 409, spiral grooves 416 formed on the circumferential surface of a vortex cylinder 413 for separating liquid from compressed air with centrifugal force after forming vortex flow and draining liquid in keeping with the vortex flow of compressed air on the basis of labyrinth principle, an electric motor 433 located inside of a vortex cylinder 413, a centrifugal impeller 408 and an over driver 436 installed on the shaft 435 of an electric motor 433, an automatic controller 438 installed on an electric motor 433, a speed sensor 449 located on a shaft 435 of an electric motor 433 and connected with an automatic controller 438 through an electric line, multiple air passages 450 formed on the circumferential surface of a vortex cylinder 413 at the bottom side of spiral grooves 416, and an outlet pipe 432 installed on the circumferential surface of a vortex cylinder 413 at the bottom side of spiral grooves 416, a center drain hole 423 formed at the lower side of a vortex cylinder 413, a drain plate 424 located on the bottom side of spiral grooves 416, multiple drain holes 422 formed on a drain plate 424, a drain bowl 419 located on the bottom side of a drain plate 424, a drain outlet 411 installed for connecting a liquid trap 441 on the bottom side of a drain bowl 419.

### ADVANTAGEOUS EFFECTS

Compared to conventional technologies such as are represented in the foregoing citations and other prior arts, a compressed air cleaner utilizing a centrifugal impeller and spiral grooves according to the present invention is noted with the following advantages: no filter use, no clog problem with carbonated sludge, superior filtering efficiencies with small loss of pressure, energy saving, small, simple and compact structure, everlasting service term without periodic filter replacement, abatement of maintenance and repair fee on the various tools of pneumatic lines.

There are the improvements described with the followings a compressed air cleaner utilizing a centrifugal impeller and spiral grooves according to the present invention;

1. Upgrading purification efficiency: it may be improved for compressed air purification efficiency without pressure loss and sludge clogging. Thus it may be prepared a liquid drain gap between the circumferential side of spiral grooves and the inner wall of housing on the basis of Labyrinth principle, since it is generated efficiently for the vortex flow of compressed air, further liquid is better separated with a centrifugal force from the vortex flow of compressed air and passed downwardly with a gravitational force to the liquid drain holes through a liquid drain gap between the circumferential side of spiral grooves and the inner wall of housing. Furthermore the vortex flow of compressed air may be not passed through a liquid drain gap between the circumferential side of spiral grooves and the inner wall of housing on the basis of Labyrinth principle. Therefore a liquid drain gap is formed between the circumferential side of spiral grooves 216 and inner wall of a housing 209, a spiral air passage is formed between the circumferential side of spiral grooves 216 and inner wall of a housing 209 on the basis of labyrinth principle.

2. Horizontal piping: It may be usually installed for a compressed air cleaner on a horizontal pipe in industrial facility. Thus it is improved for arranging an inlet nipple and an outlet nipple horizontally on the structure of a housing. Therefore an inlet air passage 231 and an inlet air passage 232 are formed horizontally with same level on the circumferential surface of a housing 209.

3. A shaft fixed with both ends: It may be lack of the durability on the structure of a one arm shaft fixed with one end, Thus it may be improved for a mechanical life with a shaft fixed with both ends.

4. Low mass cast-manufacturing cost: It may be improved for simplifying with low manufacturing cost and easy maintenances.

5. Simple structure with a small number of parts: Lot of complex parts including a filter, a porous separation cylinder are eliminated on its structure of a compressed air cleaner. Thus it is improved for a mass cast producing on the basis of three major parts.

6. Easy maintenance: It is improved for assembling and disassembling on the basis of three major parts.

### BRIEF DESCRIPTION OF THE DRAWINGS

FIG. 1 is a perspective view for schematically showing a compressed air cleaner utilizing a centrifugal impeller and spiral grooves according to the present invention;

FIG. 2 is a perspective view for schematically showing a centrifugal impeller according to the present invention;

FIG. 3 is a perspective view for schematically showing a hallow shaft fixed on its both ends according to the present invention;

FIG. 4 is an operational view for schematically showing a compressed air cleaner according to the present invention;

FIG. 5 is an A-A cross sectional view for schematically showing a first vortex room in FIG. 1;

FIG. 6 is a B-B cross sectional view for schematically showing a second vortex room in FIG. 1;

FIG. 7 is a C-C cross sectional view for schematically showing a third vortex room in FIG. 1;

FIG. 8 is a D-D cross sectional view for schematically showing multiple liquid drain holes in FIG. 1;

FIG. 9 is a perspective view of another embodiment for a compressed air cleaner utilizing an electric motor according to the present invention;

FIG. 10 is an operational view of another embodiment for a compressed air cleaner utilizing an electric motor according to the present invention.

* Mark for major part of figure;

208: a centrifugal impeller 234, 236: bearings

235: a hallow shaft 216: spiral grooves

250: multiple air passages 222: multiple drain holes

### BEST MODE FOR CARRYING OUT THE INVENTION

The Invention Preferred embodiments of the present invention will be explained hereafter with reference to accompanied embodiments.

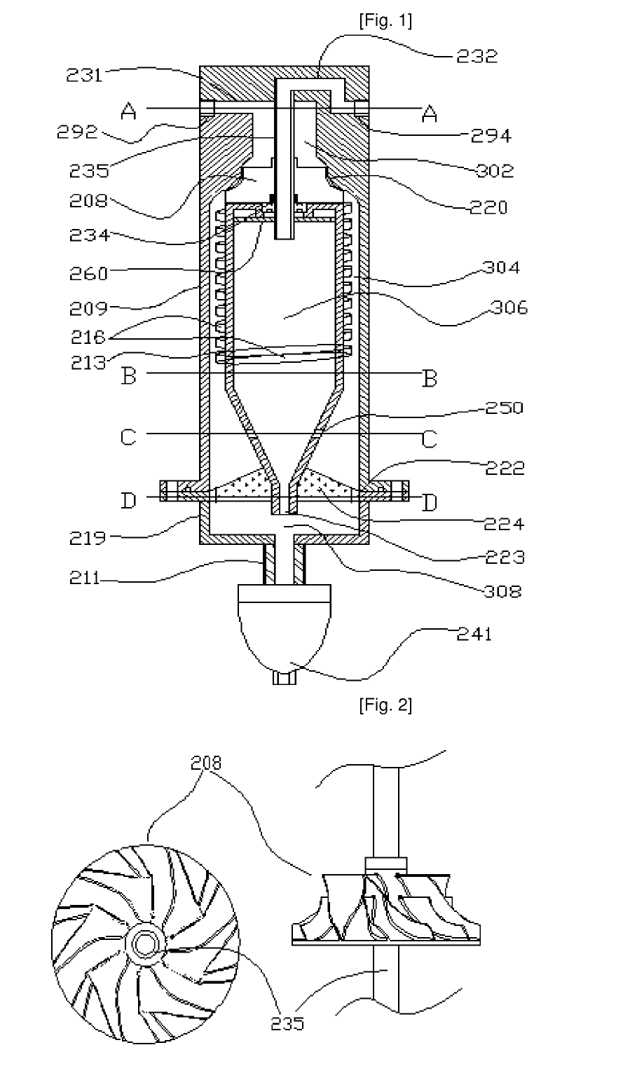

As shown in FIG. 1, a compressed air cleaner utilizing a centrifugal impeller and spiral grooves by operating with the jet power of compressed air, comprising: a vortex cylinder 213 located inside of a housing 209, a separating plate 260 located on the upper side of a vortex cylinder 213, spiral grooves 216 formed on the circumferential surface of a vortex cylinder 213 for separating liquid from compressed air with centrifugal force after forming vortex flow and draining liquid in keeping with the vortex flow of compressed air on the basis of labyrinth principle, and a hallow shaft 235 formed a compressed air passage on its axis and fixed on its both ends between a housing 209 and a vortex cylinder 213, a centrifugal impeller 208 and a bearing 234 installed on a hollow shaft 235, and multiple air passages 250 formed on the circumferential surface of a vortex cylinder 213 at the lower side of spiral grooves 216, a center drain hole 223 formed at the bottom side of a vortex cylinder 213, a drain plate 224 located on the bottom side of spiral grooves 216, multiple drain holes 222 formed on a drain plate 224, a drain bowl 219 located on the bottom side of a drain plate 224, a drain outlet 211 installed for connecting a liquid trap 241 on the bottom side of a drain bowl 219.

As shown in FIG. 1, an inlet nipple 292 fixed on an inlet air passage 231 and an outlet nipple 294 fixed on an inlet air passage 232 formed horizontally with same level on the circumferential surface of a housing 209;

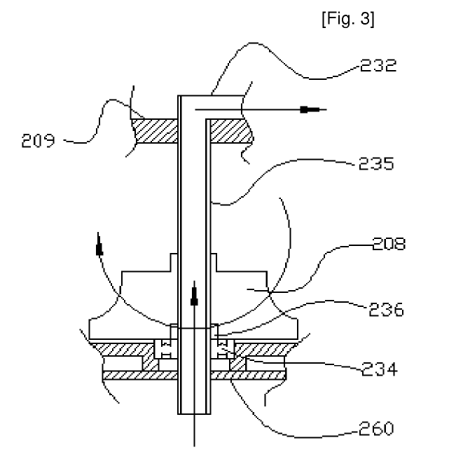

As shown in FIG. 3, a hallow shaft 235 having a compressed air passage inside of through the direction of its axis and inserted between a housing 209 and a drain bowl 219;

As shown in FIG. 1, the various kind of a rotation fan comprising an axial flow fan, a centrifugal flow fan, an inclination flow fan, a sirocco fan used instead of a centrifugal impeller 208 fixed on a hallow shaft 235 for inducing centrifugal vortex flow in the front of spiral grooves 216;

As shown in FIG. 1 and FIG. 5, a first vortex room 302 formed inside of a housing 209 for inducing the vortex flow of compressed air through an inlet air passage 231 with an inclination angle;

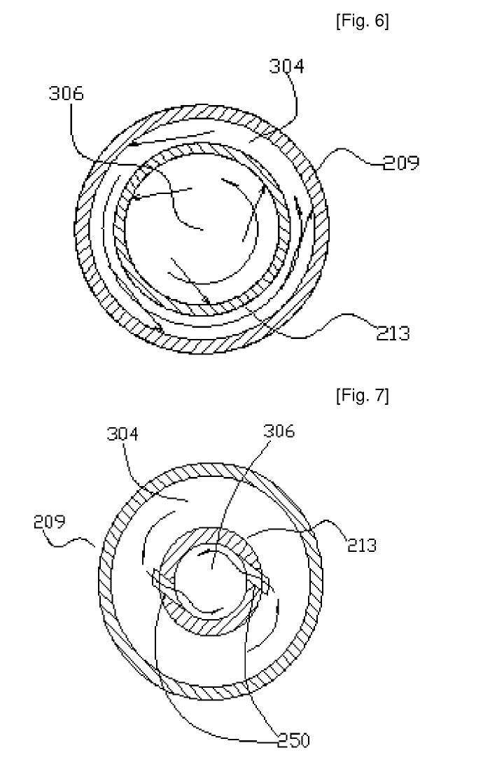

As shown in FIG. 1 and FIG. 6, a second vortex room 304 formed inside of a housing 209, a liquid drain gap formed between the circumferential side of spiral grooves 216 and inner wall of a housing 209, a spiral air passage formed between the circumferential side of spiral grooves 216 and inner wall of a housing 209 on the basis of labyrinth principle;

As shown in FIG. 1 and FIG. 6, a third vortex room 306 formed inside of a vortex cylinder 213;

As shown in FIG. 1, usage as an air cleaner with connecting a compressor for purification pollution substances from air in atmosphere.

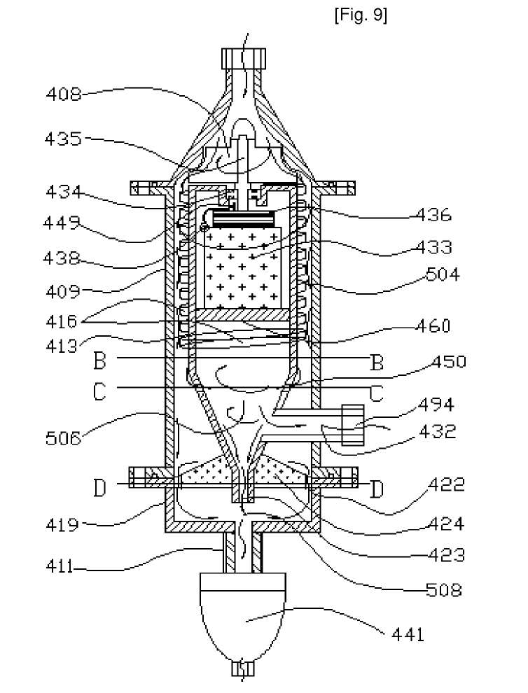

As shown in FIG. 9, A compressed air cleaner utilizing a centrifugal impeller and spiral grooves by operating with the rotation power of an electric motor, comprising: a vortex cylinder 413 located inside of a housing 409, spiral grooves 416 formed on the circumferential surface of a vortex cylinder 413 for separating liquid from compressed air with centrifugal force after forming vortex flow and draining liquid in keeping with the vortex flow of compressed air on the basis of labyrinth principle, an electric motor 433 located inside of a vortex cylinder 413, a centrifugal impeller 408 and an over driver 436 installed on the shaft 435 of an electric motor 433, an automatic controller 438 installed on an electric motor 433, a speed sensor 449 located on a shaft 435 of an electric motor 433 and connected with an automatic controller 438 through an electric line, multiple air passages 450 formed on the circumferential surface of a vortex cylinder 413 at the bottom side of spiral grooves 416, and an outlet pipe 432 installed on the circumferential surface of a vortex cylinder 413 at the bottom side of spiral grooves 416, a center drain hole 423 formed at the lower side of a vortex cylinder 413, a drain plate 424 located on the bottom side of spiral grooves 416, multiple drain holes 422 formed on a drain plate 424, a drain bowl 419 located on the bottom side of a drain plate 424, a drain outlet 411 installed for connecting a liquid trap 441 on the bottom side of a drain bowl 419;

As shown in FIG. 9, a centrifugal flow fan, an inclination flow fan, a sirocco fan used instead of a centrifugal impeller 408 fixed on a shaft 435 of an electric motor 433 for inducing centrifugal vortex flow in the front of spiral grooves 416;

As shown in FIG. 9, an over driver 436 installed on the shaft 435 of an electric motor 433 as an one way clutch and a transmission;

As shown in FIG. 9, a second vortex room 504 formed inside of a housing 409, a liquid drain gap formed between the circumferential side of spiral grooves 416 and inner wall of a housing 409, a spiral air passage formed between the circumferential side of spiral grooves 416 and inner wall of a housing 409 on the basis of labyrinth principle;

As shown in FIG. 9, a third vortex room 506 formed inside of a vortex cylinder 413;

As shown in FIG. 9, a drain outlet 411 located at the center on the bottom side of a liquid bowl 419 for draining liquid through a liquid trap 441;

As shown in FIG. 9, usage as an air cleaner with connecting a compressor for purification pollution substances from air in atmosphere.

### MODE FOR THE INVENTION

Hereafter preferred embodiments of the operation method of a compressed air cleaner utilizing a centrifugal impeller and spiral grooves with operating by the jet stream of compressed air on the pneumatic lines would be explained.

As shown in FIG. 1 is a perspective view for schematically showing a compressed air cleaner utilizing a centrifugal impeller and spiral grooves according to the present invention, a centrifugal compressed air cleaner by operating with the jet power of compressed air is comprised of the followings: a vortex cylinder 213 located inside of a housing 209, a separating plate 260 located on the upper side of a vortex cylinder 213, spiral grooves 216 formed on the circumferential surface of a vortex cylinder 213 for separating liquid from compressed air with centrifugal force after forming vortex flow and draining liquid in keeping with the vortex flow of compressed air on the basis of labyrinth principle, and a hallow shaft 235 fixed on its both ends between a housing 209 and a vortex cylinder 213, a centrifugal impeller 208 and a bearing 234 installed on a hollow shaft 235, and multiple air passages 250 formed on the circumferential surface of a vortex cylinder 213 at the lower side of spiral grooves 216, a center drain hole 223 formed at the bottom side of a vortex cylinder 213, a drain plate 224 located on the bottom side of spiral grooves 216, multiple drain holes 222 formed on a drain plate 224, a drain bowl 219 located on the bottom side of a drain plate 224, a drain outlet 211 installed for connecting a liquid trap 241 on the bottom side of a drain bowl 219.

As shown in FIG. 1, a separating plate 260 is located for separating the flow of compressed air on an electric motor 233 inside of a vortex cylinder 213.

As shown in FIG. 1, an inlet air passage 231 and an inlet air passage 232 is formed horizontally with same level on the circumferential surface of a housing 209. Thus it has an advantage for installing centrifugal compressed air cleaner as a commercial goods on a conventional piping facility in industry site.

As shown in FIG. 1, a centrifugal compressed air cleaner has a simple structure for easy manufacturing and maintenances on the basis of three major parts including a housing 209, a drain bowl 219 and a vortex cylinder 213. Therefore it has advantages for low manufacturing cost and easy maintenance, assembly and disassembly.

Further a hollow shaft 235 a hallow shaft 235 is formed a compressed air passage through the direction of its axis and inserted between a housing 209 and a drain bowl 219. furthermore a screen (not shown) may be covered for preventing carryover liquid on a multiple air passages 250 formed on the circumferential surface of a vortex cylinder 213 at the lower side of spiral grooves 216.

As shown in FIG. 2 is a perspective view for schematically showing a centrifugal impeller according to the present invention, a centrifugal impeller 208 may be rotated freely with the jet power of high-pressure gas stream as indicated by the arrows. thus a centrifugal impeller 208 is used for separating liquid from compressed air centrifugally on the difference of gas-liquid gravity. Wherein a centrifugal impeller 208 fixed rotatably on a hallow shaft 235 may be used for replacing with the various kind of a rotation fan comprising an axial flow fan, a centrifugal flow fan, an inclination flow fan, a sirocco fan for inducing centrifugal vortex flow in the front of spiral grooves 216.

As shown in FIG. 3 is a perspective view for schematically showing a hallow shaft fixed on its both ends according to the present invention, a hallow shaft 235 is formed a compressed air passage on it axis and fixed on its both ends between a housing 209 and a vortex cylinder 213. thus it has advantages for a higher speed rotation and a longer mechanical life by avoiding the vibration problem of a centrifugal impeller 208 as a rotation body. therefore it is an advantage for a better cleaning efficiency of compressed air.

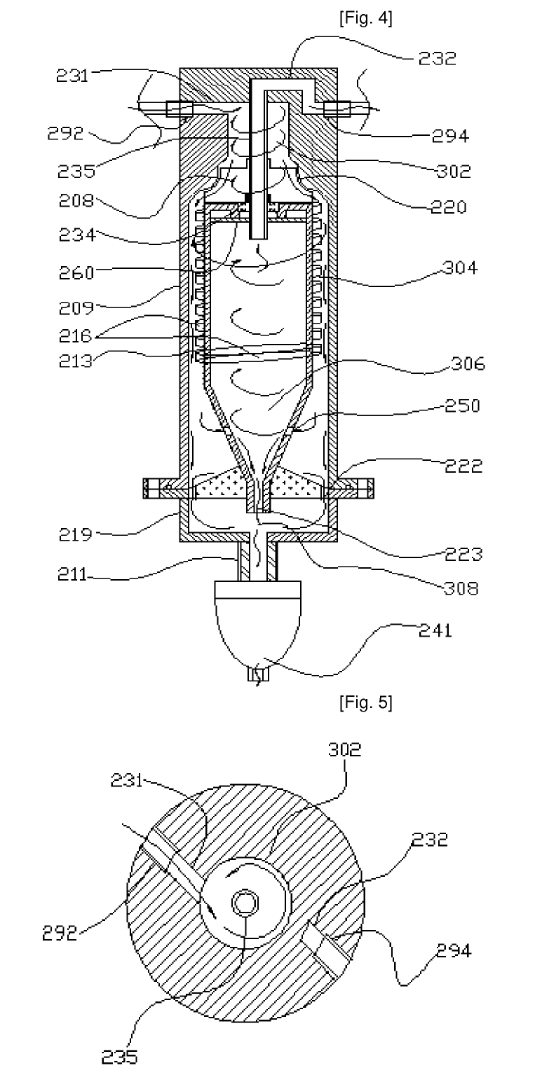

As shown in FIG. 4 is an operational view for schematically showing a compressed air cleaner according to the present invention, in the case of installing a centrifugal air cleaner on the middle stream of main pneumatic line, a centrifugal impeller 208 may be rotated with the dynamic power of compressed air through an inlet pipe 231, and the compressed air is flowed as a vortex through the line of spiral grooves 216 formed circumferentially on a vortex cylinder 213 as in a second vortex room 304 formed inside of a housing 209. thus the liquid is separated from compressed air centrifugally on the basis of a different specific gravity between compressed air and liquid as indicated by the arrows.

Further the compressed air is flowed inside of a compressed air cleaner, and then the compressed air is formed in the flow of centrifugal vortex with aid of a centrifugal impeller 208 and spiral grooves 216, further the compressed air stream is separated liquid containing sludge substances on the basis of different specific gravity (1:1000, gas:liquid, especially water) at a second vortex room 304.

Furthermore the liquid containing sludge substances is gathered with gravity effect at a liquid drain trap 241 through a liquid drain outlet 211, meanwhile the clean gas, especially ‘fresh compressed air’, is discharged for supplying for the various pneumatic tools (not shown) through a outlet air passage 232 from a third vortex room 306 via a hallow shaft 235. Wherein, as shown in FIG. 3, a hallow shaft 235 formed a compressed air passage through the direction of its axis. Wherein a liquid drain trap 241 is used for draining sludge liquid and for preventing the leak of compressed air as a well-known pneumatic tool in industry.

As shown in FIG. 5 is a A-A cross sectional view for schematically showing a first vortex room in FIG. 1, a first vortex room 302 formed inside of a housing 209 for inducing the vortex flow of compressed air through an inlet air passage 231 with an incline angle. Further the compressed air is impinged and rotated inside wall of a first vortex room 302. thus the compressed air is flowed in a second vortex room 304 as in spiral vortex flow through a shroud 220 or the structure of a fluid guide after rotating a centrifugal impeller 208 around a hollow shaft 235.

As shown in FIG. 6 is a B-B cross sectional view for schematically showing a second vortex room in FIG. 1, a second vortex room 304 formed inside of a housing 209. Thus a vortex air stream is formed along spiral grooves 216 on the basis of the labyrinth principle. Therefore liquid is separated liquid from a vortex air stream centrifugally and is flow with the aqua viscosity along the inner wall of a housing 209 downwardly. Wherein a liquid drain gap is formed between the circumferential side of spiral grooves 216 and the inner wall of a housing 209, and a liquid drain gap is formed as a spiral air passage between the circumferential side of spiral grooves 216 and inner wall of a housing 209 on the basis of labyrinth principle.

As described in above statement, a centrifugal compressed air cleaner may be operated without using a centrifugal impeller 208 with an fluid guide (not shown). since it is possible to separate liquid from compressed air with passing a spiral air passage between the circumferential side of spiral grooves 216 and inner wall of a housing 209 on the basis of labyrinth principle.

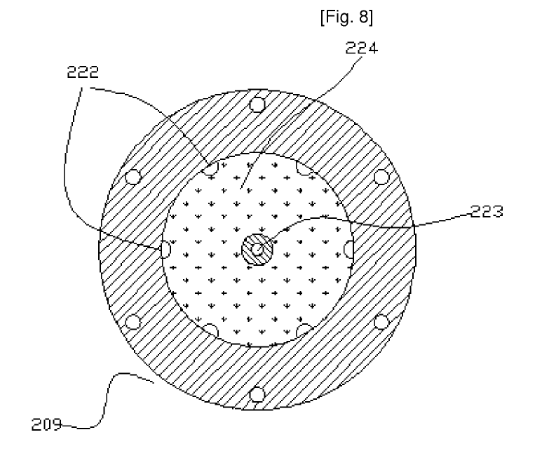

As shown in FIG. 7 is a C-C cross sectional view for schematically showing a third vortex room in FIG. 1, Meanwhile compressed gas is flowed in a third vortex room 306 inside of on a vortex cylinder 213 through multiple air passage 250. therefore the rest of liquid is separated from compressed air for better dehumidification. wherein the rest of liquid is drained through a center drain hole 223, therefore the separated liquid is gathered in a drain bowl 219.

As shown in FIG. 8 is a D-D cross sectional view for schematically showing multiple liquid drain holes in FIG. 1, the separated liquid is flowed downwardly along the inner wall surface of a housing 409 with aqua viscosity under gravity effect. Thus the separated liquid is gathered in a drain bowl 219.

As described in above statement, the liquid containing sludge substances is flowed on the inner wall surface of a housing 209 due to aqua viscosity and gravity effect, wherein the liquid containing sludge substances may be not blown out or mixed again with the gas stream on the basis of aqua viscous cohesion phenomenon. Therefore it has advantages for a better cleaning efficiency of compressed air without the loss of pressure and the carryover of liquid in discharging compressed air.

Meanwhile A compressed air cleaner utilizing a centrifugal impeller and spiral grooves by operating with the jet power of compressed air may be used as an air cleaner with connecting a compressor for purification pollution substances from air in atmosphere.

Hereafter another embodiments of the operation method of a compressed air cleaner utilizing a centrifugal impeller and spiral grooves with operating by the rotation power of an electric motor on the pneumatic lines would be explained.

As shown in FIG. 9 is a perspective view of another embodiment for a compressed air cleaner utilizing an electric motor according to the present invention, A compressed air cleaner by operating with the rotation power of an electric motor is comprised of the followings: a vortex cylinder 413 located inside of a housing 409, spiral grooves 416 formed on the circumferential surface of a vortex cylinder 413 for separating liquid from compressed air with centrifugal force after forming vortex flow and draining liquid in keeping with the vortex flow of compressed air on the basis of labyrinth principle, an electric motor 433 located inside of a vortex cylinder 413, a centrifugal impeller 408 and an over driver 436 installed on the shaft 435 of an electric motor 433, an automatic controller 438 installed on an electric motor 433, a speed sensor 449 located on a shaft 435 of an electric motor 433 and connected with an automatic controller 438 through an electric line, multiple air passages 450 formed on the circumferential surface of a vortex cylinder 413 at the bottom side of spiral grooves 416, and an outlet pipe 432 installed on the circumferential surface of a vortex cylinder 413 at the bottom side of spiral grooves 416, a center drain hole 423 formed at the lower side of a vortex cylinder 413, a drain plate 424 located on the bottom side of spiral grooves 416, multiple drain holes 422 formed on a drain plate 424, a drain bowl 419 located on the bottom side of a drain plate 424, a drain outlet 411 installed for connecting a liquid trap 441 on the bottom side of a drain bowl 419.

As shown in FIG. 9, a separating plate 460 is located for separating the flow of compressed air on an electric motor 433 inside of a vortex cylinder 413.

As shown in FIG. 9, a screen (not shown) may be covered for preventing carryover liquid on a multiple air passages 450 formed on the circumferential surface of a vortex cylinder 413 at the lower side of spiral grooves 416.

As shown in FIG. 9, a centrifugal impeller 408 fixed on a shaft 435 of an electric motor 433 may be used for replacing with the various kind of a rotation fan comprising an axial flow fan, a centrifugal flow fan, an inclination flow fan, a sirocco fan for inducing centrifugal vortex flow in the front of spiral grooves 416.

As shown in FIG. 9, As described in above statement, a centrifugal impeller 408 is fixed on an electric motor 433 through an impeller shaft 435, and a centrifugal impeller 408 may be installed on an over driver 436 for spinning higher rotation speed even in a low speed of an electric motor, thus centrifugal vortex stream is generated with the rotation of an impeller shaft 435. Wherein said over driver 436 may be provided for increasing the speed of a centrifugal impeller 408 in the case of installing with a low rotation speed of an electric motor.

Furthermore, As shown in FIG. 9, in the case of rapid strong gas stream, a centrifugal impeller 408 may be rotated freely again with the jet power of compressed air without using the rotation power of an electric motor 433 with installation of an over driver 436 having the function of an one-way clutch and RPM (revolution per minute) sensor 449 as a feedback system, thus a centrifugal compressed air cleaner may be operated for keeping strong centrifugal separation efficiency all the time even under small pressure differences in the middle of main pneumatic line. Wherein said over driver 436 may be provided for increasing the speed of a centrifugal impeller 408 in the case of installing with a low rotation speed of an electric motor.

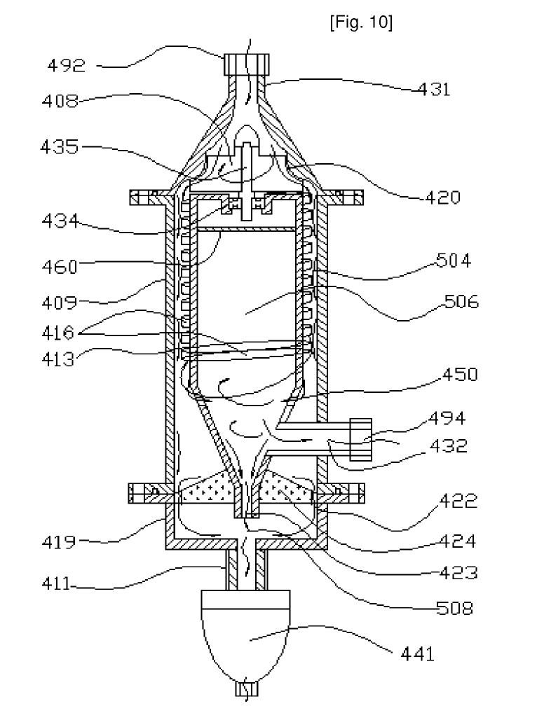

As shown in FIG. 10 is an operational view of another embodiment for a compressed air cleaner utilizing an electric motor according to the present invention, the compressed air is flowed as a vortex through the line of spiral grooves 416 formed circumferentially on a vortex cylinder 413 as in a second vortex room 504 formed inside of a housing 409. thus the liquid is separated from compressed air centrifugally on the basis of a different specific gravity between compressed air and liquid as indicated by the arrows.

Wherein B-B, C-C, and D-D cross sectional view for schematically showing a first vortex room in FIG. 9 is referenced with a B-B cross sectional view for schematically showing a second vortex room in FIG. 1, a C-C cross sectional view for schematically showing a third vortex room in FIG. 1 and a D-D cross sectional view for schematically showing multiple liquid drain holes in FIG. 1 for another embodiment of a centrifugal compressed air cleaner according to this invention.

Further the compressed air is flowed inside of a compressed air cleaner, and then the compressed air is formed in the flow of centrifugal vortex with aid of a centrifugal impeller 408 and spiral grooves 416, further the compressed air stream is separated liquid containing sludge substances on the basis of different specific gravity (1:1000, gas:liquid, especially water) at a second vortex room 504.

Furthermore the liquid containing sludge substances is gathered with gravity effect at a liquid drain trap 441 through a liquid drain outlet 411, meanwhile the clean gas, especially ‘fresh compressed air’, is discharged for supplying for the various pneumatic tools (not shown) through a outlet air passage 432 from a third vortex room 506. Wherein a liquid drain trap 441 is used for draining sludge liquid and for preventing the leak of compressed air as a well-known pneumatic tool in industry.

As shown in FIG. 10, As described in above statement, a second vortex room 504 formed inside of a housing 409. Thus a vortex air stream is formed along spiral grooves 416 on the basis of the labyrinth principle. Therefore liquid is separated liquid from a vortex air stream centrifugally and is flow with the aqua viscosity along the inner wall of a housing 409 downwardly. Wherein a liquid drain gap is formed between the circumferential side of spiral grooves 416 and the inner wall of a housing 409, and a liquid drain gap is formed as a spiral air passage between the circumferential side of spiral grooves 416 and inner wall of a housing 409 on the basis of labyrinth principle.

Meanwhile compressed gas is flowed in a third vortex room 506 inside of on a vortex cylinder 413 through multiple air passage 450. therefore the rest of liquid is separated from compressed air for better dehumidification. wherein the rest of liquid is drained through a center drain hole 423, therefore the separated liquid is gathered in a drain bowl 419. Hence the separated liquid is flowed downwardly along the inner wall surface of a housing 409 with aqua viscosity under gravity effect. Therefore the separated liquid is gathered in a drain bowl 419.

As shown in FIG. 10, As described in above statement, the liquid containing sludge substances is flowed on the inner wall surface of a housing 409 due to aqua viscosity and gravity effect, wherein the liquid containing sludge substances may be not blown out or mixed again with the gas stream on the basis of aqua viscous cohesion phenomenon. Therefore it has advantages for a better cleaning efficiency of compressed air without the loss of pressure and the carryover of liquid in discharging compressed air.

Meanwhile A compressed air cleaner utilizing a centrifugal impeller and spiral grooves by operating with an electric motor is used as an air cleaner with connecting a compressor for purification pollution substances from air in atmosphere.

As described in above statement, said air means gas comprising vapor, ammonia, nitrogen, hydrogen, ozone and oxygen et al. in the form of continuous gases, and liquid comprise water, lubricant oil, rust, dust and carbonated material et al.

Finally a compressed air cleaner utilizing a centrifugal impeller and spiral grooves according to the present invention may be installed and operated with a refrigeration system for making optimum air purification efficiency.

### INDUSTRIAL APPLICABILITY

Compared to conventional technologies such as are represented in the foregoing citations and other prior arts, a compressed air cleaner utilizing a centrifugal impeller and spiral grooves according to the present invention is noted with the following advantages: no filter use, no clog problem with carbonated sludge, superior filtering efficiencies with small loss of pressure, energy saving, small, simple and compact structure, everlasting service term without periodic filter replacement, abatement of maintenance and repair fee on the various tools of pneumatic lines.

There are the improvements described with the followings a compressed air cleaner utilizing a centrifugal impeller and spiral grooves according to the present invention;

1. Upgrading purification efficiency: it may be improved for compressed air purification efficiency without pressure loss and sludge clogging. Thus it may be prepared a liquid drain gap between the circumferential side of spiral grooves and the inner wall of housing on the basis of Labyrinth principle, since it is generated efficiently for the vortex flow of compressed air, further liquid is better separated with a centrifugal force from the vortex flow of compressed air and passed downwardly with a gravitational force to the liquid drain holes through a liquid drain gap between the circumferential side of spiral grooves and the inner wall of housing. Furthermore the vortex flow of compressed air may be not passed through a liquid drain gap between the circumferential side of spiral grooves and the inner wall of housing on the basis of Labyrinth principle. Therefore a liquid drain gap is formed for separating liquid from compressed air between the circumferential side of spiral grooves 216 and inner wall of a housing 209, a spiral air passage is formed annually for passing the vortex flow of compressed air between the circumferential side of spiral grooves 216 and inner wall of a housing 209 on the basis of labyrinth principle.

2. Horizontal piping: It may be usually installed for a compressed air cleaner on a horizontal pipe in industrial facility. Thus it is improved for arranging an inlet nipple and an outlet nipple horizontally on the structure of a housing. Therefore an inlet air passage 231 and an outlet air passage 232 are formed horizontally with same level on the circumferential surface of a housing 209.

3. A shaft fixed with both ends: It may be lack of the durability on the structure of a one-arm shaft fixed with one end. Therefore it may be improved for a mechanical life with a shaft fixed with both ends.

4. Low mass cast-manufacturing cost: It may be improved for simplifying with low mass cast-manufacturing cost and easy maintenances.

5. Simple structure with a small number of parts: Lot of complex parts including a filter, a porous separation cylinder are eliminated on its structure of a compressed air cleaner. Thus it is improved for a mass cast producing on the basis of three major parts.

6. Easy maintenance: It is improved for assembling and disassembling on the basis of three major parts.

### SEQUENCE LISTING

Optional Blank

1-15. (canceled)

16. A compressed air cleaner utilizing a centrifugal impeller and spiral grooves by operating with the jet power of compressed air, comprising: a housing in which a centrifugal impeller rotates with a compressed air, to which a housing and a gas passage cylinder are mounted so that a vortex having a centrifugal force length wisely passes by a predetermined distance, the housing having an annular vortex room located between the inner wall of the housing and the gas passage cylinder; and multiple air passages formed on the circumferential surface of a vortex cylinder, multiple drain holes formed on a drain plate.

17. A compressed air cleaner as claimed in claim 1, comprising: a center drain hole formed at the bottom side of a vortex cylinder.

18. A compressed air cleaner as claimed in claim 1, comprising: a hallow shaft having a compressed air passage inside of through the direction of its axis and inserted between a housing and a drain bowl.

19. A compressed air cleaner as claimed in claim 1, comprising: the various kind of a rotation fan comprising an axial flow fan, a centrifugal flow fan, an inclination flow fan, a sirocco fan used instead of a centrifugal impeller fixed on a hallow shaft for inducing centrifugal vortex flow in the front of spiral grooves.

20. A compressed air cleaner as claimed in claim 1, comprising: spiral grooves formed on a gas passage cylinder.

21. A compressed air cleaner as claimed in claim 1, comprising: a second vortex room formed inside of a housing.

22. A compressed air cleaner as claimed in claim 1, comprising: a third vortex room formed inside of a vortex cylinder.

23. A compressed air cleaner as claimed in claim 1, comprising: usage as an air cleaner with connecting a compressor for purification pollution substances from air in atmosphere.

24. A compressed air cleaner utilizing a centrifugal impeller and spiral grooves by operating with the rotation power of an electric motor and the jet power of compressed air, comprising: a housing in which a centrifugal impeller rotates with the rotation power of an electric motor and the jet power of compressed air, to which a housing and a gas passage cylinder are mounted so that a vortex having a centrifugal force length wisely passes by a predetermined distance, the housing having an annular vortex room located between the inner wall of the housing and the gas passage cylinder; and multiple air passages formed on the circumferential surface of a vortex cylinder, multiple drain holes formed on a drain plate.

25. A compressed air cleaner as claimed in claim 24, comprising: the various kind of a rotation fan comprising an axial flow fan, a centrifugal flow fan, an inclination flow fan, a sirocco fan used instead of a centrifugal impeller fixed on a shaft of an electric motor for inducing centrifugal vortex flow in the front of spiral grooves.

26. A compressed air cleaner as claimed in claim 24, comprising: spiral grooves formed on a gas passage cylinder.

27. A compressed air cleaner as claimed in claim 24, comprising: a second vortex room formed inside of a housing.

28. A compressed air cleaner as claimed in claim 24, comprising: a third vortex room formed inside of a vortex cylinder.

29. A compressed air cleaner as claimed in claim 24, comprising: a liquid trap on the bottom side of a housing.

30. A compressed air cleaner as claimed in claim 24, comprising: usage as an air cleaner with connecting a compressor for purification pollution substances from air in atmosphere.
